(19) United States
(12) Patent Application Publication
(10) Pub. No.: US 2013/0038539 A1
(43) Pub. Date: Feb. 14, 2013

(54) ILLUMINATED COMPUTER KEYBOARD

(71) Applicant: Hortensia Villarreal, San Antonio, TX (US)

(72) Inventor: Hortensia Villarreal, San Antonio, TX (US)

(21) Appl. No.: 13/209,412

(22) Filed: Aug. 14, 2011

(51) Int. Cl. G06F 3/02

(52) U.S. Cl. 345/170

(57) ABSTRACT

The present invention is an illuminated computer keyboard that includes a computer keyboard, a plurality of computer keyboard keys disposed on the computer keyboard and a plurality of phosphors coatings that coat the computer keyboard keys. The keyboard also includes a plurality of lights that are disposed behind the computer keyboard keys to enhance illumination of the computer keyboard keys and an on and off toggle switch disposed on the computer keyboard that turns the lights on or off.

### TECHNICAL FIELD

### Background

Typing on a computer keyboard at night or in a dimly lit environment can be extremely difficult and inconvenient, often requiring a person to strain their vision or bend over a computer keyboard to see the keyboard keys. Currently there are limited alternatives to conventional computer keyboards that can avoid the hassle of limited visibility in a dimly lit or dark environment.

The present invention generally relates to a computer keyboard. More specifically, the invention is an illuminated computer keyboard.

It is an object of the invention to provide a computer keyboard that can be illuminated and used in a dark or dimly lit environment.

It is an object of the invention to provide a computer keyboard illuminated with a safe and effective chemical composition.

What is really needed is a computer keyboard that can be illuminated and used in a dark or dimly lit environment and that is illuminated with a safe and effective chemical composition.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overhead perspective view of an illuminated computer keyboard, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

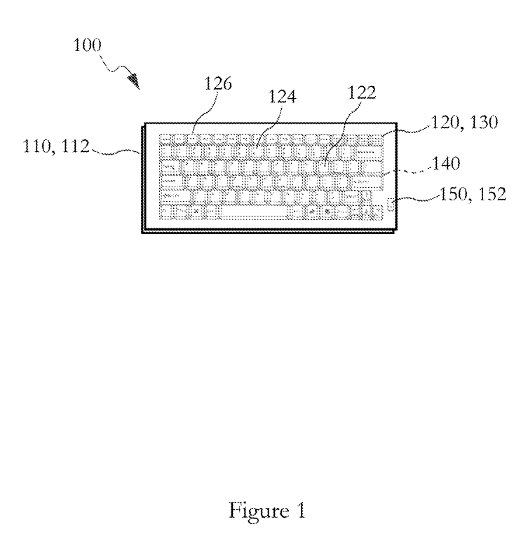

FIG. 1 illustrates an overhead perspective view of an illuminated computer keyboard 100, in accordance with one embodiment of the present invention. The illuminated computer keyboard 100 includes a computer keyboard 110, a plurality of computer keyboard keys 120, a plurality of fluorescent phosphors coatings 130, a plurality of lights 140 and a on and off switch 150.

The computer keyboard 110 can be a standard QWERT keyboard 112 or any other suitable keyboard. The computer keyboard keys 120 are incorporated into the computer keyboard 110 and can be any suitable type and number of computer keyboard keys, although typically the computer keyboard keys are letter keyboard keys 122, number keyboard keys 124 or functional keyboard keys 126 such as F1, Ctrl (Control) and other suitable functional keyboard keys. The fluorescent phosphors coatings 130 coat the computer keyboard keys 120 to provide a relative long and persistent illumination that ensures that the fluorescent phosphors coatings 130 do not dim or fade over time or during a period of usage. The lights 140 are disposed behind each of the computer keyboard keys 120 and enhance the illumination of the computer keyboard keys 120 coated with the fluorescent phosphors coatings 130. The on and off switch 150 is a toggle switch 152 that turns the lights 140 on and off as desired by a user. The on and off switch 150 is typically disposed on the front of the computer keyboard 110, although the on and off switch 150 can be disposed on any suitable location on the computer keyboard 110. The lights 140 and on and off switch 150 can be any suitable lights or on and off switch.

The illuminated computer keyboard functions much like a traditional computer keyboard but with the added benefit of illuminated keyboard keys that allow a user to type easily in the dark, making it a useful tool for those who need to work at night. When using the illuminated computer keyboard, each keyboard key is coated with high-quality fluorescent phosphors that have long persistence, thereby ensuring that the bright lights do not dim or fade over time. The illuminated computer keyboard is ideal for use by students and those that work nighttime hours. The illuminated computer keyboard will be readily available at electronic retail stores and is compatible with all computer makes and models, including Mac computers. To ensure product versatility, the illuminated computer keyboard is provided with a variety of glow in the dark color options such as blue, pink, yellow, and even rainbow colors.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An illuminated computer keyboard, comprising:
a computer keyboard;
a plurality of computer keyboard keys disposed on said computer keyboard;
a plurality of phosphors coatings that coat said computer keyboard keys;
a plurality of lights to enhance illumination of said computer keyboard keys; and
an on and off switch that turns said lights on or off.

2. The keyboard according to claim 1, wherein said computer keyboard is a standard QWERT keyboard.

3. The keyboard according to claim 1, wherein said computer keyboard keys include a plurality of letter keyboard keys.

4. The keyboard according to claim 1, wherein said computer keyboard keys include a plurality of number keyboard keys.

5. The keyboard according to claim 1, wherein said computer keyboard keys include a plurality of functional keyboard keys.

6. The keyboard according to claim 1, wherein said phosphors coatings are fluorescent phosphors coatings.

7. An illuminated computer keyboard, comprising:
a computer keyboard;
a plurality of computer keyboard keys disposed on said computer keyboard;
a plurality of phosphors coatings that coat said computer keyboard keys;
a plurality of lights that are disposed behind said computer keyboard keys to enhance illumination of said computer keyboard keys; and
an on and off switch disposed on said computer keyboard that turns said lights on or off.

8. The keyboard according to claim 7, wherein said computer keyboard is a standard QWERT keyboard.

9. The keyboard according to claim 7, wherein said computer keyboard keys include a plurality of letter keyboard keys.

10. The keyboard according to claim 7, wherein said computer keyboard keys include a plurality of number keyboard keys.

11. The keyboard according to claim 7, wherein said computer keyboard keys include a plurality of functional keyboard keys.

12. The keyboard according to claim 7, wherein said phosphors coatings are fluorescent phosphors coatings.

13. The keyboard according to claim 7, wherein said on and off switch is a toggle switch.

14. An illuminated computer keyboard, comprising:
a computer keyboard with a front;
a plurality of computer keyboard keys disposed on said computer keyboard;
a plurality of phosphors coatings that coat said computer keyboard keys;
a plurality of lights that are disposed behind said computer keyboard keys to enhance illumination of said computer keyboard keys; and
an on and off toggle switch disposed on said computer keyboard that turns said lights on or off.

15. The keyboard according to claim 14, wherein said computer keyboard is a standard QWERT keyboard.

16. The keyboard according to claim 14, wherein said computer keyboard keys include a plurality of letter keyboard keys.

17. The keyboard according to claim 14, wherein said computer keyboard keys include a plurality of number keyboard keys.

18. The keyboard according to claim 14, wherein said computer keyboard keys include a plurality of functional keyboard keys.

19. The keyboard according to claim 14, wherein said phosphors coatings are fluorescent phosphors coatings.

20. The keyboard according to claim 14, wherein said toggle switch is disposed on said front of said computer keyboard.
